(19) United States
(12) Patent Application Publication
(10) Pub. No.: US 2008/0267005 A1
(43) Pub. Date: Oct. 30, 2008

(54) Applicator system and method of use

(75) Inventor: Jon Reinprecht, Watertown, CT (US)

Correspondence Address: Tyco Healthcare Group LP, 60 MIDDLETOWN AVENUE, NORTH HAVEN, CT, 06473, US

(73) Assignee: TYCO HEALTHCARE GROUP LP

(21) Appl. No.: 11/789,399

(22) Filed: Apr. 24, 2007

(51) Int. Cl. B01F 15/04; B01F 15/00; B67D 5/52; B67D 5/60

(52) U.S. Cl. 366/162.3; 222/145.6; 222/137; 366/172.1

(57) ABSTRACT

Disclosed is an applicator system for mixing, homogenizing and/or emulsifying two or more solutions and/or substances prior to application. The system includes a first and a second container of solution, a hand-held homogenizer having a homogenizing assembly and an applicator assembly configured to fluidly communicate the first and second containers with the homogenizing assembly. The solution from each container is mixed by the homogenizing assembly when the solution is dispensed from the containers. The applicator assembly may be integrally formed with the homogenizer and may be configured to include an outlet for dispensing the homogenized solution. The outlet may form an applicator tip or a connection for releasably securing a hose or tube. The homogenizing assembly may be integrally formed with the applicator and may include rotors and stators.

### BACKGROUND

1. Technical Field

The present disclosure relates to applicators, applicator systems, and the like, for mixing, homogenizing and/or emulsifying two or more solutions and/or substances prior to application, and more particularly, to an applicator system for emulsifying a polyurethane based adhesive/sealant and water prior to application.

2. Background of Related Art

Polymers and other synthetic materials are currently being developed for use in internal and external wound closure. “Bioadhesives” are known in the art, as are various methods for applying the bioadhesive. Bioadhesives offer many significant advantages over conventional wound closure methods, i.e., using sutures, staples, clips or other suitable mechanical fasteners. Bioadhesives are faster and simpler to apply, have a tendency to promote quicker wound closure with less scaring, and eliminate the need for a follow up visit to remove the mechanical fasteners.

Most bioadhesives are composed of components that have a tendency to immediately activate and in some instances, rapidly polymerize when combined with one another. Because of this immediate activation and/or rapid polymerization of the bioadhesive, the components comprising the bioadhesive may not be combined until immediately prior to application. Conventional applicators for mixing the bioadhesive components prior to application generally include a mixing chamber or common conduit where the solutions are combined, i.e., mixed, as the solutions pass therethrough. The consistency of this mixture may vary depending on the types of solutions being combined, their quantities, and the speed at which the solutions pass through the mixing chamber.

In an application requiring a homogenized solution, the components must be mixed separate from the applicator using a stand-alone or portable homogenizer, thus ensuring proper mixing. When preparing the homogenized solution for application a surgeon is limited to mixing small amounts because once the solutions are combined, it may begin to harden. Any hardening prior to application may cause the applicator tip to clog and prevent an even application of the solution.

Conventional applicators or syringes for mixing two solutions are known in the art. U.S. Pat. No. 3,767,085 to Cannon et al. discloses such a device. Specifically, the '085 patent discloses a double barrel carpule type syringe for the mixing of an elastomeric base material and an accelerator. The mixing syringe includes, on a distal end thereof, a common mixing and dispensing chamber provided with a rotary agitator driven from a motor on the syringe. The mixing syringe further includes a double plunger through which manual depression thereof results in the discharge of the fluids into the mixing and dispensing chamber.

Conventional applicators, like that disclosed in the '085 patent, lack the ability to emulsify solutions. Adhesive/sealants, which are highly viscous, do not readily combine with low viscosity solutions, such as water. The emulsification of adhesive/sealant and water has been found to speed up the cure time of the adhesive and reduce post cure swelling. As with the separately homogenized solution, a surgeon is limited to mixing small amounts of the adhesive/sealant otherwise risk hardening of the solution and clogging of the applicator tip during application.

In addition to not being able to emulsify two or more solutions, conventional applicators require the manual depression of a plunger by a surgeon to eject the solution form the syringes, and ultimately discharge the mixed solution from the applicator. This manual depression may result in a non-uniform discharge of mixed solution from the applicator. In many applications a uniform discharge is required to ensure a proper seal, coating, adherence or the like.

Therefore, it would be beneficial to have an applicator system capable of mixing, homogenizing and/or emulsifying two or more solutions prior to application.

It would further be beneficial to have an applicator system that automatically dispensed a homogenized solution.

### SUMMARY

According to the present disclosure a system for homogenizing two or more solutions is provided. The system includes at least a first and a second source of solution, a hand held homogenizer having a homogenizing assembly, and an applicator assembly. The applicator assembly is configured to fluidly communicate the at least first and second sources of solution with the homogenizing assembly, wherein solution from each of the at least first and second source of solution is mixed by the homogenizing assembly upon dispensing of the solution from the first and second sources of solution The first and second sources of solution may comprise syringes or metering pumps.

The applicator assembly may be integrally formed with the homogenizer. The homogenizer may be configured to rotate the homogenizer assembly at about 1,000 to about 35,000 RPM, preferably 1,000 to 25,000 RPM. The applicator assembly may further be configured to include an outlet for dispensing a homogenized solution. The outlet may form an applicator tip for applying the homogenized solution. The outlet may instead form a connection for releasably securing a hose or tube.

The homogenizing assembly may include rotors and stators. The homogenizing assembly may be integrally formed with the applicator assembly. The homogenizing assembly may also be disposable. The applicator system may further include an activation mechanism for automatically supplying the solution from the first and second sources of solution. The activation mechanism may include a button or switch mounted on the applicator assembly.

According to another aspect of the disclosure, there is provided an applicator assembly for mixing two or more solutions. The applicator assembly includes a housing defining at least two inlets and a mixing chamber, wherein each of the inlets are configured to releasably engage a respective one of the two or more sources of solution. The inlets are in fluid communication with the mixing chamber. The applicator assembly further includes a mixing assembly rotatably mounted within the mixing chamber. The mixing assembly may be configured to operably connect to a motor, wherein a solution from each of the two or more sources of solution are mixed with one another by the mixing assembly as the solutions pass through the mixing chamber.

The housing further defines an outlet. The mixing assembly may be integrally formed with the motor. The two or more sources of solution are syringes or metering pumps. The mixing assembly may be disposable.

The applicator assembly may further include an activation mechanism for selectively releasing the solutions from the two or more sources of solution. The activation mechanism may include a dial for selectively activating the applicator assembly. The activation mechanism may include a motor.

Yet another aspect of this disclosure provides a method for mixing and applying two or more solutions. The method includes the steps of providing an applicator assembly having a housing configured for receiving two or more sources of solution, and a hand held homogenizer having a homogenizing assembly operably connected to the housing, wherein said housing is further configured to fluidly communicate each of said two or more sources of solution with said homogenizing assembly. The method further including the steps of providing two or more sources of solution, operably connecting said two or more sources of solution with said applicator assembly, dispensing solution from each of said two or more sources of solution into said housing, and activating said homogenizing assembly.

### BRIEF DESCRIPTION OF THE DRAWINGS

The foregoing summary, as well as the following detailed description will be better understood when read in conjunction with the appended figures. For the purpose of illustrating the present disclosure, a preferred embodiment is shown. It is understood, however, that the present disclosure is not limited to the precise arrangement and instrumentalities shown.

FIG. 1 is a front, elevational view of the applicator system according to an embodiment of the present disclosure;

FIG. 2 is a side, elevational view of an applicator assembly and a first container of the applicator system of FIG. 2;

FIG. 3 is a partial, cross-sectional, front, elevational view of the applicator assembly of the applicator system of FIGS. 1 and 2;

FIG. 4 is a front, elevational view of an alternate embodiment of an applicator system according to the present disclosure;

FIG. 5 is a partial, side, elevational view of an applicator and a first container of solution of the applicator system of FIG. 4;

FIG. 6 is a partial, cross-sectional, front, elevational view of the applicator system of FIGS. 4 and 5;

FIG. 7 is a side, elevational view of another embodiment of the applicator system of the present disclosure;

FIG. 8 is a front, elevational view of the applicator system of FIG. 7; and

FIG. 9 is a partial, longitudinal, cross-sectional side, elevational view of the applicator system of FIGS. 7 and 8.

### DETAILED DESCRIPTION OF EMBODIMENTS

Although the present disclosure relates specifically to the emulsification and/or homogenization of a polymer adhesive and water, aspects of the present disclosure can be incorporated into any apparatus, system or method where two or more solutions require mixing, homogenization, emulsification, or the like, prior to application. Embodiments of the presently disclosed applicator will now be described in detail with reference to the drawings in which like reference numerals designate identical or corresponding elements in each of the several views. As used herein, the term “distal” refers to that portion of the instrument, or component thereof which is further from the user while the term “proximal” refers to that portion which is closer to the user.

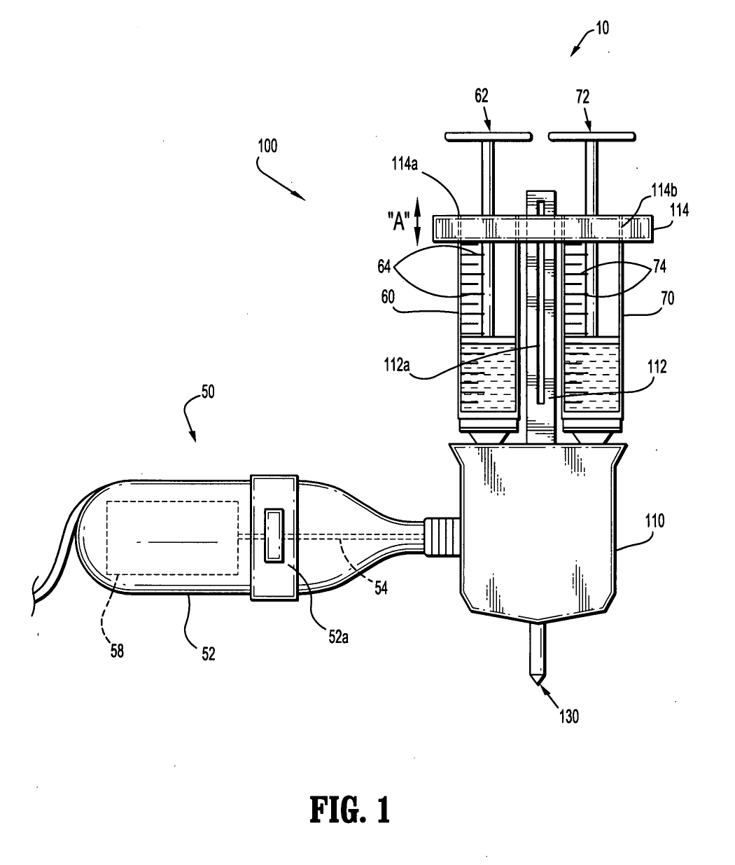

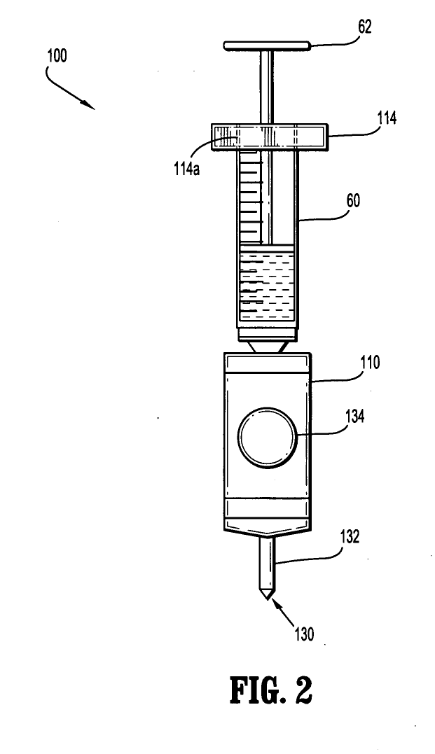

Referring initially to FIGS. 1-3, an embodiment of the presently disclosed homogenizing applicator system is shown generally as applicator system 10. Applicator system 10 includes a hand-held homogenizer 50, an applicator assembly 100 and two containers 60, 70 for selectively dispensing solution, e.g. syringes.

As seen in FIGS. 1-3, applicator assembly 100 includes a housing 110, an arm 112 extending from housing 110, and a mount 114 fixedly attached to a distal end of arm 112. Mount 114 is configured to define openings 114a, 114b for selectively receiving respective syringes 60, 70 therein. Openings 114a, 114b may be configured to accommodate any number of solution containing vessels or sources, including, but not limited to, syringes, bottles, tubes and hoses. Mount 114 may be slideably supported within a longitudinal groove 112a defined in arm 112. In this manner, mount 114 may be selectively positioned along extension arm 112 as indicated by arrow “A”. Thus, the spacing or distance between housing 110 and mount 114 may be adjusted to accommodate syringes or other vessels of varying dimensions.

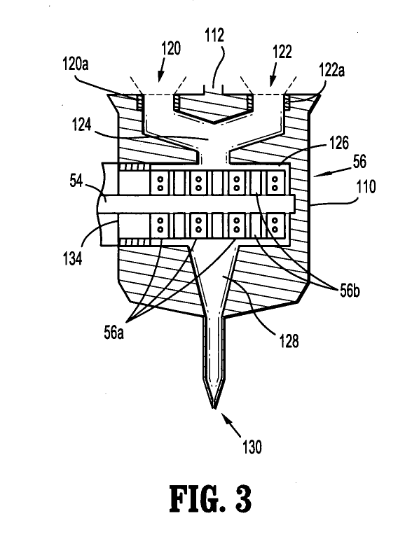

With particular reference to FIG. 3, housing 110 includes first and second inlets 120, 122, respectively, an entrance conduit 124 fluidly interconnecting first and second inlets 120, 122, a mixing chamber 126 fluidly connected to entrance conduit 124, an exit conduit 128 fluidly connected to mixing chamber 126, and an outlet 130 fluidly connected to exit conduit 128. Housing 110 defines an opening 134 formed therein that is configured for selectively engaging and receiving a mixing assembly 56 of homogenizer 50. Inlets 120, 122 fluidly communicate with mixing chamber 126 via entrance conduit 124. Outlet 130 may be configured, as shown in FIGS. 1-3, as a needle 132 for directly applying or dispensing of the homogenized solution to a target site. Outlet 130 may instead be configured for operable fluid engagement with a conduit, hose, tube or the like, for remotely applying the homogenized solution.

Inlets 120, 122 of housing 110 may be configured for selective engagement with syringes 60, 70, respectively. Each inlet 120, 122 may include a threaded portion 120a, 122a for selectively receiving syringes 60, 70.

Homogenizer 50 may be any known, commercially available portable homogenizer. Homogenizer 50 may operate at a single speed or may be capable of operating at variable speeds. Homogenizer 50 is preferably configured to operate in the range of about 1,000 to about 35,000 RPM, preferable 1,000-25000 RPM. Homogenizer 50 may be battery operated.

As seen in FIGS. 1 and 3, homogenizer 50 includes a handle 52 housing a drive means, such as a motor 58, a drive shaft 54 extending from drive means 58, and a mixing assembly 56 supported on a distal end of shaft 54. Mixing assembly 56 comprises rotors 56a and stators 56b. Rotors 56a and stators 56b may be made from stainless steel, polymers or the like. Mixing assembly 56 may include any number of rotors 56a and stators 56b in any configuration. Rotors 56a and stators 56b may be disposable, replaceable and/or sterilizable. Mixing assembly 56 of homogenizer 50 is rotatably mounted in mixing chamber 126 to homogenize the solutions introduced from syringes 60, 70. Homogenizer 50 may include a lever, button or other suitable activation switch 52a for activating homogenizing assembly 56.

In operation, syringes 60, 70 are inserted through openings 14a, 114b of mount 114 and engageably coupled in threaded portions 120a, 122a of inlets 120, 122, respectively. Once syringes 60, 70 have been properly received within respective inlets 120, 122 of housing 110, homogenizer 50 may be activated. Depression of respective plungers 62, 72 of syringes 60, 70 causes the individual solutions contained within each syringe 60, 70 to be expelled into inlets 120, 122, respectively, and received within or advanced into entrance conduit 124. The individual solutions from syringes 60, 70 are first combined in entrance conduit 124 to form a solution mix before being introduced or advanced into mixing chamber 126. Once the solution mix enters mixing chamber 126, mixing assembly 56 causes the further mixing, homogenization, emulsification or the like, of the solution mix to form a homogenized solution. The resulting homogenized solution is further advanced through mixing chamber 126 and through exit conduit 128 before being forced out through outlet 130.

The independent configuration of syringes 60,70 permit a user to adjusted the amount of solution expelled from each syringe 60, 70 as necessary to provide a homogenized solution of proper concentration exiting outlet 130. Equal amounts of each solution may be dispersed by depressing plungers 62, 72 equal amounts. Depressing the plunger of one syringe more than another will result in a higher concentration of that individual solution in the resulting homogenized solution. The rate of which the individual solutions are dispersed, and thus the rate at which the homogenized solution exits through outlet 130, may also be varied. For example, the greater the force applied to plungers 62, 72, the faster the homogenized solution will exit outlet 130.

Syringes 60, 70 may include markings or gradations 64, 74 for determining the amount of solution being introduced into housing 110 of applicator system 100. Syringes 60, 70 may instead be replaced by a metering pump, such as syringe pump, diaphragm pump, gear pump or the like, for selectively supplying or delivering solution to inlets 120, 122 of housing 110.

In an alternate embodiment, the solutions supplied to inlets 120, 122 may be permitted to flow without any external pressure, i.e. depression of a plunger. In this manner, the rotation of mixing assembly 56 creates a suction that may draw the solutions from within containers or syringes 60, 70 into mixing chamber 126 and expels the homogenized solution through outlet 130. The rate of flow may be varied by adjusting the speed at which the mixing assembly 56 rotates or by modifying the configuration of mixing chamber 126.

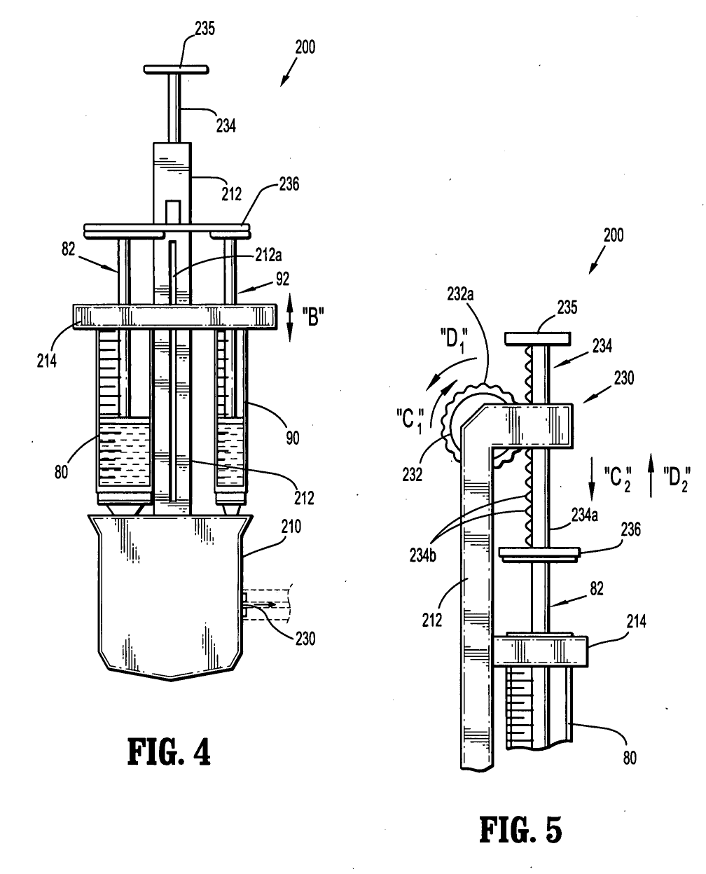

Referring now to FIGS. 4-6, an alternate embodiment of an applicator assembly of an applicator system is shown generally as applicator assembly 200. Applicator assembly 200 includes first and second containers or syringes 80, 90. Applicator assembly 200 is substantially similar to applicator assembly 100 and thus will only be discussed herein to the extent necessary to identify differences in construction and operation.

Applicator assembly 200 includes a housing 210, an arm 212 extending from housing 210 and a mount 214 selectively positionable about arm 212. Mount 214 may be slidably supported within a longitudinal groove 212a defined in arm 212. In this manner, mount 214 may be selectively positioned along arm 212 as indicated by arrow “B”. The distal end of arm 212 is further configured to receive an activation mechanism 230 for selectively dispensing the solutions from syringes 80, 90 into housing 210 of applicator assembly 200.

Activation mechanism 230 includes a dial 232 supported on arm 212 and a plunger assembly 234. Plunger assembly 234 includes an elongated member 234a having teeth 234b along a length thereof, a button or tab 235 supported on elongated member 234a for activating activation mechanism 230, and a planar member 236 supported on elongated member 234 for engaging plungers 82, 92 of syringes 80, 90. A distal end of extension arm 212 is configured to slidable receive and support elongated member 234. Dial 232 is rotatably mounted within the distal end of extension arm 212 and including teeth 323a is configured to engage teeth 234a of elongated member 234.

In operation, rotation of dial 232 in a first direction (arrow “C1”) causes longitudinal motion or advancement of elongated member 234 and planar member 236 in a first direction (arrow “C2”). As planar member 236 engages plungers 82, 92 of syringes 80, 90 fluid is ejected therefrom into housing 210. Rotation of dial 232 in a second direction, opposite the first direction, (arrow “D1”) causes longitudinal motion or retraction of planar member 236 in a second, opposite the first direction (arrow “D2”). By varying the rate at which dial 232 is rotated in the first direction a surgeon may vary the rate at which solutions are simultaneously ejected from applicator assembly 200.

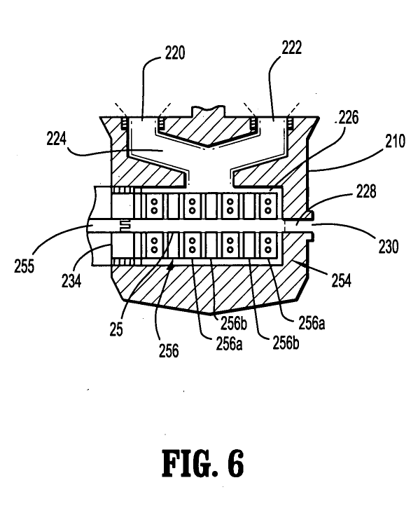

With particular reference to FIG. 6, housing 210 includes first and second inlets 220, 222, respectively, an entrance conduit 224 fluidly interconnecting the first and second inlets 220, 222, a mixing chamber 226 fluidly connected to entrance conduit 224, an exit conduit 228 fluidly connected to mixing chamber 226, and an outlet 230 fluidly connected to exit conduit 128. Mixing chamber 226 is configured to include a homogenizing assembly 256. Homogenizing assembly 256 comprises a shaft 254, and rotors 256a and stators 256b securely affixed to shaft 255. Homogenizing assembly 256 is configured to be maintained with housing 210. Housing 210 further defines an opening 234 configured for selectively engaging a homogenizing motor. The proximal end of shaft 254 is configured for operable engagement with a shaft 255 extending from the homogenizing motor to rotate homogenizing assembly 256. In this manner, homogenizing motors of various speeds and configurations may be interchangeably connected to housing 210 of applicator assembly 200 to rotate homogenizing assembly 256. Applicator assembly 200 may be disposable, replaceable and/or sterilizable.

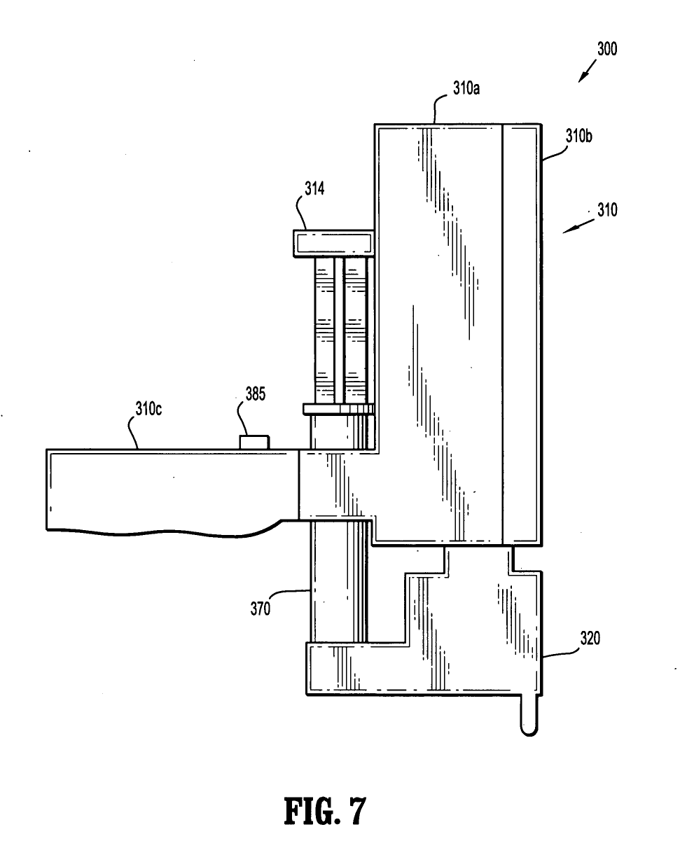

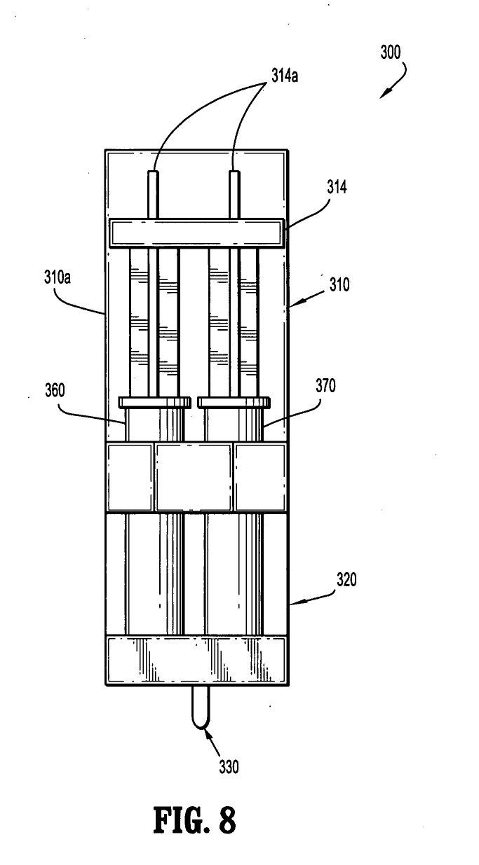

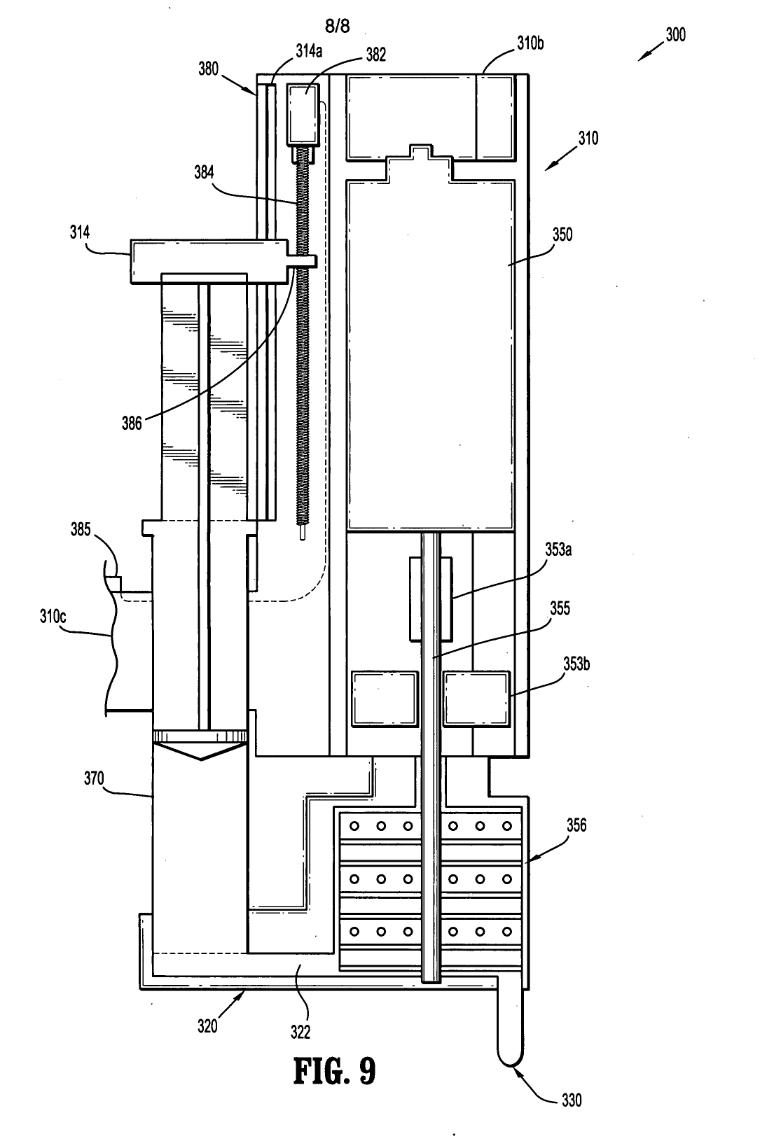

Referring now to FIGS. 7-9, an alternate embodiment of an applicator system is shown generally as applicator system 300. Applicator system 300 includes a housing 310 configured and adapted to selectively receive and support first and second containers of solution 360, 370, a homogenizing motor 350 supported on housing 310, a homogenizing assembly 356 extending from motor 350 and housing 310, and an applicator assembly 320 supported on housing 310 and configured to receive homogenizing assembly 356.

Housing 310 includes a base 310a for encasing homogenizer motor 350, a cover 310b selectively supportable on base 310a for accessing and replacing homogenizing motor 350, and a handle assembly 310c extending from base 310a for providing a secure grip for applicator system 300. Base 310a is further configured to selectively retain first and second containers of solution 360, 370. A button or lever 314 is slidably mounted within grooves 314a of base 310a and is configured to simultaneously depress plungers 362, 372 of first and second containers 360, 370. Button 314 is positioned such that button 314 may be depressed using the thumb of the hand that is gripping handle assembly 310c, thus enabling single handed operation of applicator system 300. As with the prior applicator systems, the rate at which button 314 is depressed may function to control the rate at which the homogenized solution is dispensed.

Applicator assembly 320 is operably connected to housing 310 and each of first and second containers 360, 370. Applicator assembly 320 may be integrally formed with housing 310 or may instead be selectively attachable/detachable thereto. In this manner, applicator assembly 320 may be replaced between uses or as deemed necessary by a surgeon.

In use or operation, solution from first and second containers 360, 370 is introduced into an entrance conduit 322 before entering a mixing chamber 326. The rate of introduction of solution from containers 360, 370, as discussed above, is controlled by the rate in which button 314 is depressed. Rotatably mounted within mixing chamber 326 is homogenizing assembly 356 for mixing, homogenizing and/or emulsifying the solutions. Homogenizing assembly 356 is operably connected to homogenizing motor 350 by a shaft 355 extending therethrough. Homogenizing motor 350 rotates shaft 355 at speeds of anywhere between about 1,000 and about 25,000 RPM, thus, stabilizers 353a, 353b positioned about shaft 355 prevent excessively vibration thereof. Once the mix of solution is homogenized, the homogenized solution is released through outlet 330 formed in applicator assembly 320 and may be applied to a wound or other target tissue site. Outlet 330 may instead be configured for fluid communication with and releasable engagement to a tube, hose or the like, for remote application of the homogenized solution.

Optionally, applicator system 300 includes an activation mechanism 380 for automatically depressing button 314 of housing 320. Activation mechanism 380 includes a motor 382 or other drive device and a threaded rod 384 extending therefrom. Threaded rod 384 is rotatably mounted within housing 320 and is operably connected to motor 380. Button 314 includes a tab portion 386 which extends into housing 320 and is configured to be engaged with threaded rod 384. Tab portion 386 of button 314 is configured such that as threaded rod 384 is rotated by motor 382, tab portion 386 operably engages threaded rod 384. In this manner, rotation of threaded rod 384 causes axial movement of button 114. Rotation of threaded rod 384 in a first direction causes downward movement of button 114, while rotation of threaded rod 284 in a second direction cause button 114 to be retracted.

Activation mechanism 380 may further include an activation button or switch 385. Switch 385 is operably connected to motor 380 and may be positioned anywhere on housing 310. Preferably, switch 385 is mounted on handle member 310c such that it may be activated by a finger or thumb of the user. Alternatively, motor 385 may be remotely controlled, whereby activation is accomplished through the use of a foot switch or other remote means. Motor 385 may instead be configured to activate upon attainment of a preset condition, i.e. homogenizing motor 350 reaching a predetermined speed.

Activation mechanism 380 may configured to depress or retract button 314 under a variety of conditions and at a variety of rates. It is envisioned that applicator assembly 300 may include more than one activation mechanism 380 for selectively depressing a second or subsequent buttons. In this manner, different solutions may be ejected at different rates, thereby altering the properties of the mixed solution.

Solutions for use with any of the applicator systems disclosed herein include, and are not limited to, polymers, oils, alcohols, water and the like.

Thus, it should be understood that various changes in form, detail and operation of the homogenizing applicator system of the present disclosure may be made without departing from the spirit and scope of the present disclosure.

What is claimed is:

1. A system for homogenizing two or more solutions, said system comprising:
at least a first and a second source of solution;
a hand held homogenizer having a homogenizing assembly; and
an applicator assembly configured to fluidly communicate said at least first and second sources of solution with said homogenizing assembly, wherein solution from each of said at least first and second source of solution is mixed by said homogenizing assembly upon dispensing of said solution from said first and second sources of solution

2. The system of claim 1, wherein said at least first and second sources of solution comprise syringes or metering pumps.

3. The system of claim 1, wherein said applicator assembly is integrally formed with the homogenizer.

4. The system of claim 1, wherein said homogenizer is configured to rotate said homogenizer assembly at about 1,000 to about 35,000 RPM.

5. The system of claim 1, wherein said applicator assembly is further configured to include an outlet for dispensing said homogenized solution.

6. The system of claim 5, wherein said outlet for dispensing said homogenized solution forms an applicator tip for applying said homogenized solution.

7. The system of claim 5, wherein said outlet for dispensing said homogenized solution forms a connection for releasably securing a hose or tube.

8. The system of claim 1, wherein the homogenizing assembly includes rotors and stators.

9. The system of claim 1, wherein the homogenizing assembly is integrally formed with said applicator assembly.

10. The system of claim 1, wherein the homogenizing assembly is disposable.

11. The system of claim 1, further including an activation mechanism for automatically supplying the solution from said at least first and second sources of solution.

12. The system of claim 11, wherein the activation mechanism includes a button or switch mounted on said applicator assembly.

13. An applicator assembly for mixing two or more solutions, said applicator assembly comprising:
a housing defining at least two inlets and a mixing chamber, each of said inlets being configured to releasably engage a respective one of said two or more sources of solution and being in fluid communication with said mixing chamber; and
a mixing assembly rotatably mounted within said mixing chamber of said housing, said mixing assembly configured to be operably connectable to a motor, wherein a solution from each of said two or more sources of solution are mixed with one another by said mixing assembly as said solutions pass through said mixing chamber.

14. The applicator assembly of claim 11, wherein the housing further defines an outlet.

15. The applicator assembly of claim 11, wherein said mixing assembly is integrally formed with said motor.

16. The applicator assembly of claim 11, wherein said two or more sources of solution are syringes or metering pumps.

17. The applicator assembly of claim 11, wherein said mixing assembly is disposable.

18. The applicator assembly of claim 11, further including an activation mechanism for selectively releasing said solutions from said two or more sources of solution.

19. The applicator assembly of claim 16, wherein the activation mechanism includes a dial for selectively activating said applicator assembly.

20. The applicator assembly of claim 18, wherein the activation mechanism includes a motor.

21. A method for mixing and applying two or more solutions, said method comprising the steps of:
providing an applicator assembly comprising:
a housing configured for receiving two or more sources of solution; and
a hand held homogenizer having a homogenizing assembly operably connected to said housing, wherein said housing is further configured to fluidly communicate each of said two or more sources of solution with said homogenizing assembly;
providing two or more sources of solution;
operably connecting said two or more sources of solution with said applicator assembly;
dispensing solution from each of said two or more sources of solution into said housing; and
activating said homogenizing assembly.
